(19) United States
(12) Patent Application Publication
(10) Pub. No.: US 2002/0056790 A1
(43) Pub. Date: May 16, 2002

(54) Micro louvers for cooling satellites

(76) Inventor: William Trimmer, Belle Mead, NJ (US)

Correspondence Address: Marc Kaufman, Esquire, Nixon Peabody LLP, 8180 Greensboro Drive, Suite 800, McLean, VA, 22102, US

(21) Appl. No.: 09/841,483

(22) Filed: Apr. 25, 2001

Related U.S. Application Data
(60) Provisional application No. 60/199,738, filed on Apr. 25, 2000.

(51) Int. Cl. B64G 1/46; B64G 1/48; B64G 1/50

(52) U.S. Cl. 244/163

(57) ABSTRACT

This invention relates to the area of satellite temperature control systems. The methods and devices disclosed allow heat to be selectively reflected away from a satellite or selectively emitted by a satellite controlling the temperature of the satellite.

### FIELD OF THE INVENTION

This invention relates to the area of satellite temperature control systems. The invention is particularly concerned with controlling heat absorption and heat emission by a satellite.

### BACKGROUND OF THE INVENTION

Controlling the temperature of satellites is a major problem. Satellites often contain sensitive electronics and other equipment that must operate within narrow temperature ranges. Uncontrolled, the temperature of a satellite can vary greatly because of changing thermal loads from sporadic equipment operation and from exposure to sunlight.

A satellite orbiting the earth will be exposed to large amounts of radiant energy from the sun, when the satellite is clear of the earth's shadow, raising the temperature of the satellite. However, once behind the earth's shadow, the amount of radiant energy the satellite is exposed to decreases significantly, dramatically lowering the temperature of the satellite.

Recent advancements have made it possible to build small sophisticated satellites. Micro satellites, generally defined as being between 10 kg and 100 kg, and nano satellites, generally defined as being less than 10 kg, are becoming more popular. These smaller satellites are a less expensive alternative to larger satellites. However, as satellite become smaller, their reduced thermal mass makes them more vulnerable to temperature swings.

### SUMMARY OF THE INVENTION

In order to control the temperature of a satellite, this invention provides using a reflective device that can be configured to curl and uncurl to control the adsorption and emission of heat by the satellite.

In one embodiment, the invention provides a method of selectively reflecting radiant energy from a satellite. The method comprises providing one or more radiant energy absorbing satellite sections and covering at least one of said radiant energy absorbing satellite sections with a reflective material. The reflective material can curl up to expose the energy absorbing satellite section when radiant energy absorption is desired.

Preferably, the reflective material is aluminum. Preferably, the reflective material uncurls to cover the energy absorbing satellite section when an electrostatic force, a magnetic force, a piezoelectric force, or a force produced by a bimorph is applied to the reflective material. Preferably the reflective material comprises a shape memory alloy.

In another embodiment, the invention provides a method of controlling the temperature. The method comprises providing a radiant energy absorbing satellite section and covering the radiant energy absorbing satellite section with a reflective material when the temperature of the satellite is above a first temperature. When the temperature of the satellite falls below a second temperature, the reflective material is curled up.

In another embodiment, the invention provides another method of controlling the temperature. The method comprises providing a radiant energy emitting satellite section and covering the radiant energy emitting satellite section with a reflective material when the temperature of the satellite is below a first temperature. When the temperature of the satellite rises above a second temperature, the reflective material is curled up.

In another embodiment, the invention provides a reflective device for satellites. The reflective device comprises a substrate and a curling member attached to the substrate. At least one of the surfaces of the curling member is reflective to radiant energy, and at least a portion of the curling member can be uncurled by application of a force.

Preferably, the curling member comprises polysilicon and is formed using a sacrificial material. Preferably, the sacrificial material is silicon dioxide. Preferably metal is deposited upon the curling member to cause its curl. Preferably, the metal is aluminum. Preferably, photolithography is used to define regions of the curling member. Preferably, silicon nitride is used as an insulating layer on the substrate, the curling member or both. Preferably, the substrate is optically clear.

### BRIEF DESCRIPTION OF THE DRAWINGS

FIG. 1 is a schematic of inter-digitated electrodes according to one embodiment of the invention.

FIG. 2 shows a Micro Louver according to one embodiment of the invention in a curled-up position, exposing at least a part of an energy absorbing satellite section.

FIG. 3 shows a Micro Louver according to the embodiment of the invention shown in FIG. 2, where the Micro Louver is in an uncurled position.

### DETAILED DESCRIPTION OF PREFERRED EMBODIMENT OF THE INVENTION

This invention is a Micro Louver for satellites which controls the absorption and emission of radiant energy. The Micro Louver provides a covering for satellites which can be rolled up to expose the satellite's surface for heat absorption and emission. Using silicon microfabrication, and other techniques known to those skilled in the art, the Micro Louver can comprise a very light weight curl of material. The light weight, simple design, is especially useful for use in micro and nano satellite designs, where maintaining the temperature and low weight of the satellite is important.

The Micro Louver comprises a sheet of reflective material that covers satellite surfaces. When desired, the sheet can be made to “curl up, uncovering the satellite surfaces and allowing radiant energy to be absorbed or emitted by the satellite. Preferably, the reflective material reflects radiant energy in the form of heat.

The Micro Louver, when uncurled, can have a reflective surface facing away from the body of the satellite, on a face towards the body of the satellite, or both. Having the reflective surface facing away from the body of the satellite allows the Micro Louver to reflect radiant energy away from the satellite. In this embodiment, radiant energy absorption by the satellite can be prevented by uncurling the Micro Louver. The uncurled Micro Louver provides a reflective barrier on the satellite's surface. Radiant energy from the sun is reflected away from the satellite, by the uncurled Micro Louver covering a surface of the satellite, cooling the satellite. In addition, satellite surfaces can be made of a radiant energy absorbing material. The satellite can then be warmed by curling the Micro Louver and exposing the absorbing material to a radiant energy emitting source, such as the sun.

The uncurled Micro Louver can alternatively have a reflective surface facing towards the body of the satellite. Having the reflective surface facing towards the surface of the satellite allows the Micro Louver to reflect radiant energy back towards the surface of the satellite. In this embodiment, the Micro Louver can be used to prevent the emission of heat by the satellite into space, thereby keeping the satellite warm.

In yet another embodiment, both the uncurled surface of the Micro Louver facing the surface of the satellite and the uncurled surface of the Micro Louver facing away from the satellite are reflective. In this embodiment, the temperature of the satellite can be controlled by curling and uncurling the Micro Louver depending on the state of the satellite relative to its environment. For example, if the satellite is emitting more heat than it is absorbing, the temperature of the satellite can be increased by uncurling the Micro Louver to cover the satellite surfaces. The temperature of the satellite can be decreased in this example, by curling up the Micro Louver to expose the satellite surfaces.

Conversely, if the satellite is absorbing more heat than it is emitting, the temperature of the satellite can be decreased by uncurling the Micro Louver and covering the satellite surfaces, or increased by curling the Micro Louver and exposing the satellite surfaces.

Some surfaces of the satellite can be exposed by curled Micro Louvers while other surfaces of the satellite are covered by the uncurled Micro Louvers. For example, the satellite can be covered in a heat absorbing material. When the satellite is to be warmed, Micro Louvers facing the sun can be curled up, exposing the surface of the satellite to sun light. On the back side of the satellite, shadowed from the sun, the Micro Louvers are uncurled to cover the heat absorbing surface of the satellite, reducing heat loss.

When the satellites needs to be cooled, the Micro Louvers on sides facing the sun can be uncurled, covering the surfaces of the satellite and reflecting the sunlight. On the back side, shadowed from the sun, the Micro Louvers can be curled, exposing the satellite surfaces and increasing the heat radiated away from the satellite into space.

In another representation, the interior of the satellite is covered by an optically clear substrate which permits the passage of radiant energy, such as glass or quartz. The Micro Louvers are then mounted on top of the clear substrate. Curling up the Micro Louvers exposes the clear substrate and allows radiant energy from space to be absorbed by the interior of the satellite. Curling the Micro Louvers can also allow the radiant energy to be emitted into space from the interior of the satellite.

Uncurling the Micro Louvers covers the clear casing preventing the satellite interior from absorbing or emitting radiant energy. For example, a set of heat fins radiating the heat generated by electronics could be allowed to radiate heat into space by uncurling the Micro Louvers, or reflect the heat back into the satellite to warm the satellite by uncurling the Micro Louvers.

In a typical fabrication procedure, the Micro Louvers can be made using silicon fabrication technology to place different layers on a substrate. The substrate can comprise a satellite surface on which the Micro Louvers are to be mounted. For example, a sacrificial layer can be deposited at appropriate regions on the surface of the substrate, and then a structural layer deposited on top of the substrate at appropriate regions. Both the sacrificial layer and the structural layer can be patterned to a desired shape, and the structural material layer can overlay the sacrificial material where desired. Methods to deposit sacrificial and structural materials on substrates are well known in the silicon fabrication field, and will not be discussed herein. The sacrificial layer is deposited so that when appropriate regions of the sacrificial material are removed, portions of the structural material are left free and unattached to the substrate.

The free and unattached regions of the structural material can be made to curl by depositing a layer on top of the structural material. For example, silicon dioxide can be used as the sacrificial material, polysilicon can be used as the structural material, and aluminum can be deposited on the top surface of the structural material. The aluminum can be applied to the top surface of the structural member under tension causing the free unattached regions of the structural material to curl. The aluminum can also act as the Micro Louver's reflective material. By varying the thickness of the structural polysilicon and aluminum, and the deposition conditions, the composite polysilicon and aluminum can be made to curl in a wide range of desirable radius of curvatures. One skilled in the art can understand that a variety of other materials and techniques can be used to make the Micro Louvers without departing from the invention.

If the Micro Louvers are configured to curl, exposing the substrate, by the tension of the structural material, a force can then be used to uncurl the Micro Louvers. The Micro Louvers can be actuated, uncurled, by application of any number of forces.

An electrostratic force is a preferred method of actuating the Micro Louvers. In one embodiment, using an electrostatic force, the curled Micro Louver and the substrate are both either conducting, or contain a conducting layer. When a voltage is applied between the curled Micro Louver and the substrate, an electrostatic force is generated causing the Micro Louver to unroll and lay flat on the substrate. When the voltage is removed, the tension within the Micro Louver causes the Micro Louver to curl back up.

Preferably, a layer of silicon nitride less than a micron, preferably less than ¾ of a micron, and even more preferably less than ½ of a micron thick is used as an insulator covering the conductors on the Micro Louvers, the substrate, or both. Preferably, a voltage of between 1 and 1000 volts is used to unroll the curl, more preferably between 10 and 500 volts, most preferably between 50 and 250 volts. The curls will typically respond to the electrostatic force rapidly, preferably in less than a second.

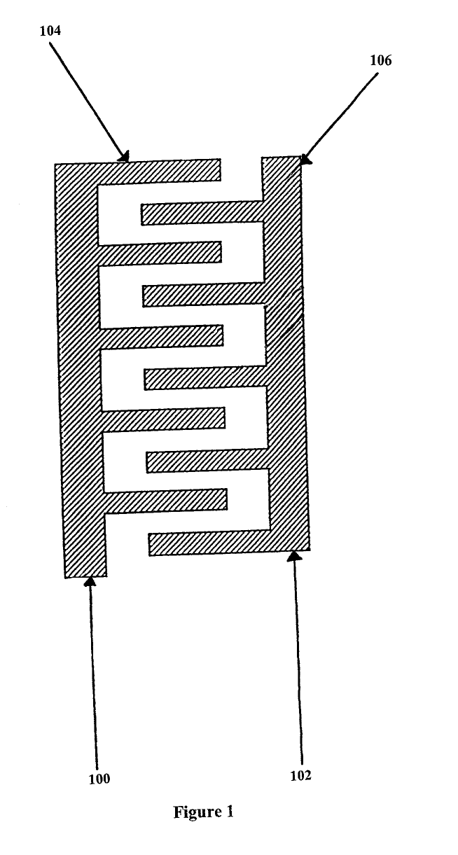

Another preferred method of actuating the curls using an electrostatic force uses inter-digitated electrodes, as shown in FIG. 1. When a voltage is applied between input 100 and input 102, an electric field is set up between the inter-digitated electrodes 104 and 106. This electric field will attract dielectric and conducting materials. Preferably, the inter-digitated electrodes are mounted on the substrate to supply the electrostatic force. When a voltage is applied between the inter-digitated electrodes 104 and 106 as shown, there is an electric field in the immediate region around the interdigitated fingers. A curled Micro Louver made out of either an insulating dielectric material, a conductor, or a combination of these materials will uncurl as it is attracted to the substrate surface.

Many other actuation forces can also be used. Another preferred actuation method uses shape memory alloy. Shape memory alloy can be used instead of the aluminum as a structural material. When the temperature goes above a predetermined shape memory alloy temperature, a force is exerted, and the curl rolls up, or unrolls, depending upon the design. Also magnetic, bimorph, piezoelectric, and other forces can be used to actuate the curl.

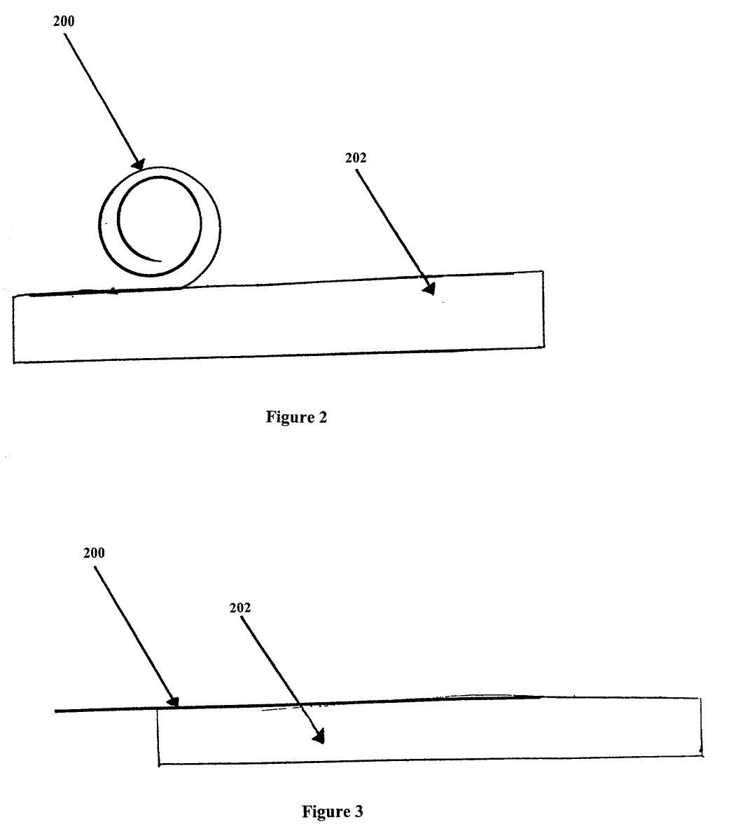

FIG. 2 and 3 show one embodiment of the present invention. FIG. 2 shows a Micro Louver 200 rolled up, exposing substrate 202. One end of Micro Louver 200 is permanently attached to substrate 202. Micro Louver 200 has at least one surface containing a reflective coating of aluminum. In the rolled up position shown in FIG. 2, substrate 202 is able to absorb radiation from space or emit radiation to space. FIG. 3 shows an activated Micro Louver 200 uncurled, covering a substrate 202. In FIG. 3, a force is applied to the Micro Louver 200 to make it uncurl. In the uncurled position, the Micro Louver 200 can prevent the substrate from absorbing energy from space or emitting energy to space.

Having now fully describe this invention, it will be appreciated by those skilled in the art that the invention can be performed within a wide range of parameters within what is claimed, without departing from the spirit and scope of the invention.

1. A method of selectively reflecting radiant energy from a satellite comprising:
providing a radiant energy absorbing satellite section; and
covering said radiant energy absorbing satellite section with a reflective material, wherein the reflective material curls up to expose said energy absorbing satellite section when radiant energy absorption is desired.

2. The method of claim 1, wherein the reflective material is aluminum.

3. The method of claim 1, wherein the reflective material uncurls to cover said energy absorbing satellite section when a force is applied.

4. The method of claim 3, wherein the force is an electrostatic force, a magnetic force, a piezo electric force, or a force produced by a bimorph.

5. The method of claim 1, wherein the reflective material comprises a shape memory alloy.

6. A method of controlling the temperature of a satellite comprising:
providing a radiant energy absorbing satellite section; and
covering said radiant energy absorbing satellite section with a reflective material when the temperature of the satellite is above a first temperature;
curling up the reflective material when the temperature of the satellite is below a second temperature.

7. The method of claim 6, wherein the reflective material uncurls to cover the energy absorbing satellite section when a force is applied.

8. The method of claim 7, wherein the force is an electrostatic force, a magnetic force, a piezoelectric force, or a force produced by a bimorph.

9. The method of claim 6, wherein the reflective material comprises a shape memory alloy.

10. A method of controlling the temperature of a satellite comprising:
providing a radiant energy emitting satellite section; and
covering said radiant energy emitting satellite section with a reflective material when the temperature of the satellite is below a first temperature;
curling up the reflective material when the temperature of the satellite is above a second temperature.

11. A reflective device for satellites comprising:
a substrate; and
a curling member attached to the substrate, wherein at least one of the surfaces of the curling member is reflective to radiant energy, and wherein at least a portion of the curling member can be uncurled by application of a force.

12. The reflective device of claim 11, wherein the curling member comprises polysilicon.

13. The reflective device of claim 11, wherein the curling member is formed using a sacrificial material.

14. The reflective device of claim 13, wherein the sacrificial material is silicon dioxide.

15. The reflective device of claim 11, wherein metal is deposited upon the curling member to cause its curl.

16. The reflective device of claim 11, wherein photolithography is used to define regions of the curling member.

17. The reflective device of claim 11, wherein:
silicon nitride is used as an insulating layer on the substrate, the curling member or both;
the curling member is formed from a silicon dioxide sacrificial layer; and
the curling member comprises polysilicon and an aluminum reflective layer.

18. The reflective device of claim 11, wherein the substrate is optically clear.
